(19) United States
(12) Patent Application Publication
(10) Pub. No.: US 2024/0392082 A1
(43) Pub. Date: Nov. 28, 2024

(54) POLYETHYLENE FILM

(71) Applicant: Toray Industries, Inc., Tokyo (JP)

(72) Inventors: Satoshi Fujiwara, Otsu-shi, Shiga (JP); Masatoshi Ohkura, Otsu-shi, Shiga (JP); Kazuma Okada, Otsu-shi, Shiga (JP)

(73) Assignee: Toray Industries, Inc., Tokyo (JP)

(21) Appl. No.: 18/691,284

(22) PCT Filed: Sep. 12, 2022
(86) PCT No.: PCT/JP2022/034018

§ 371 Date: Mar. 12, 2024

(30) Foreign Application Priority Data
Sep. 24, 2021 (JP) 2021-155229

(51) Int. Cl. C08J 5/18; C08L 23/06; C09J 7/24; C09J 7/40; C09K 5/14

(52) U.S. Cl. CPC C08J 5/18; C08L 23/06; C09J 7/243; C09J 7/405; C09K 5/14; C08J 2323/06; C08J 2423/06; C08L 2203/16; C08L 2205/025; C08L 2207/062; C08L 2207/066; C08L 2207/068

(57) ABSTRACT

A polyethylene film in which, when the direction in which tensile strength is greatest is defined as the main orientation direction, and the direction orthogonal to the main orientation direction in the plane of the film is defined as the main orientation orthogonal direction, the sum of the thermal shrinkage rate in the main orientation direction and the thermal shrinkage rate in the main orientation orthogonal direction when heated for eight hours at 100° C. is −5.0% to 10.0%, the tensile strength in the main orientation orthogonal direction is 200 MPa to 5000 MPa, and the internal haze is 0% to 80%. Provided is polyethylene film having excellent heat resistance, mechanical strength, quality, and transparency.

### CROSS REFERENCE TO RELATED APPLICATIONS

This application is the U.S. National Phase of PCT/JP2022/034018, filed Sep. 12, 2022, which claims priority to Japanese Patent Application No. 2021-155229 filed Sep. 24, 2021, the disclosures of these applications being incorporated herein by reference in their entireties for all purposes.

### FIELD OF THE INVENTION

The present invention relates to a polyethylene film that is excellent in heat resistance, mechanical strength, quality, and transparency and can be suitably used as a film for industrial materials.

### BACKGROUND OF THE INVENTION

Polyethylene films are excellent in physical properties such as lightness, moisture resistance, and chemical resistance, and therefore are widely used for various packaging materials, medical films, and the like. In particular, an ultrahigh molecular weight polyethylene film is excellent in abrasion resistance, tensile strength, and the like as compared with a general-purpose polyethylene film, and is used as a sliding material or a base material for an adhesive film. However, since an ultrahigh molecular weight polyethylene resin has an extremely high melt viscosity, it is difficult to form a film by ordinary extrusion molding or injection molding, and a film is formed mainly by a method of cutting out a compression molding material. However, in this method, since the orientation of molecular chains is insufficient, there have been problems that a mechanical strength is low, and transparency is poor because thinning is difficult.

In order to solve such problems, for example, Patent Document 1 describes an example in which a gel-like sheet obtained by dissolving an ultrahigh molecular weight polyethylene resin in a solvent is biaxially stretched and subjected to pressure treatment after removal of the solvent to obtain a thin film. In addition, Patent Document 2 describes an example in which a specific hydrocarbon-based plasticizer is mixed with an ultrahigh molecular weight polyethylene resin and extruded to obtain a biaxially stretched film. Furthermore, Patent Document 3 describes an example in which a sheet obtained by compression molding an ultrahigh molecular weight polyethylene resin is stretched at a high magnification in a uniaxial direction to obtain a high strength film.

### PATENT DOCUMENTS

Patent Document 1: Japanese Patent Laid-open Publication No. S60-228122
Patent Document 2: Japanese Patent Laid-open Publication No. H6-262679
Patent Document 3: Japanese Patent Laid-open Publication No. 2014-111384

### SUMMARY OF THE INVENTION

However, the polyethylene film described in Patent Document 1 has high strength due to stretching at a high ratio, but has insufficient relaxation of molecular chains of high molecular weight components, and has a problem in heat resistance such as thermal shrinkage during use at a high temperature. The polyethylene film described in Patent Document 2 has insufficient mechanical strength because a plasticizer is added, and also has a problem that the plasticizer bleeds out during long-term use, which deteriorates the quality. In addition, the polyethylene film described in Patent Document 3 has high strength due to a high draw ratio, but is uniaxially stretched, and has a problem in mechanical strength in a width direction. Therefore, an object of the present invention is to solve the above problems. That is, the object is to provide a polyethylene film with excellent heat resistance, mechanical strength, quality, long-term storage, and transparency.

In order to solve the above problems, the polyethylene film of the present invention has the following constitution. That is, a polyethylene film of the present invention is a polyethylene film in which, when a direction in which tensile strength is greatest is defined as a main orientation direction and a direction orthogonal to the main orientation direction in a plane of the film is defined as a main orientation orthogonal direction, a sum of a thermal shrinkage rate in the main orientation direction and a thermal shrinkage rate in the main orientation orthogonal direction when heated for eight hours at 100° C. is −5.0% or more and 10.0% or less, a tensile strength in the main orientation orthogonal direction is 200 MPa or more and 5000 MPa or less, and an internal haze is 0% or more and 80% or less.

In addition, examples of a method for producing a polyethylene film of the present invention include a production method including the following configuration. That is, the method for producing a polyethylene film of the present invention is a method for producing a polyethylene film having an internal haze of 0% or more and 80% or less, the method including a heat treatment step of biaxially stretching a sheet containing polyethylene having a weight average molecular weight Mw of 500,000 or more and 5 million or less and a plasticizer, extracting the plasticizer, and then subjecting the sheet to a heat treatment.

According to the present invention, it is possible to provide a polyethylene film with excellent heat resistance, mechanical strength, quality, long-term storage, and transparency. The polyolefin film of the present invention is excellent in the above properties, and thus can be widely and suitably used as a film for industrial materials, a surface protective film, a film for processes, a release film, a heat dissipation film, a low temperature film, a base material for an adhesive film, a sliding film, a medical film, a film for capacitors, and the like.

### DETAILED DESCRIPTION OF EMBODIMENTS OF THE INVENTION

Hereinafter, a polyethylene film of the present invention will be described. The polyethylene film of the present invention is a polyethylene film in which, when a direction in which tensile strength is greatest is defined as a main orientation direction and a direction orthogonal to the main orientation direction in a plane of the film is defined as a main orientation orthogonal direction, a sum of a thermal shrinkage rate in the main orientation direction and a thermal shrinkage rate in the main orientation orthogonal direction when heated for eight hours at 100° C. is −5.0% or more and 10.0% or less, a tensile strength in the main orientation orthogonal direction is 200 MPa or more and 5000 MPa or less, and an internal haze is 0% or more and 80% or less.

The polyethylene film is a film containing a polyethylene resin in an amount of more than 50% by mass and 100% by mass or less relative to 100% by mass of all components constituting the film. The content of the polyethylene resin in the polyethylene film is preferably 70% by mass or more and 100% by mass or less, more preferably 90% by mass or more and 100% by mass or less, still more preferably 95% by mass or more and 100% by mass or less, particularly preferably 96% by mass or more and 100% by mass or less, and most preferably 97% by mass or more and 100% by mass or less, relative to 100% by mass of all components constituting the film. The case where a plurality of components corresponding to the polyethylene resin are contained is regarded as a polyethylene film as long as the total of the components is more than 50% by mass and 100% by mass or less. In addition, the polyethylene resin is a resin in which ethylene units account for more than 50 mol % and 100 mol % or less of all the constituent units constituting the resin.

From the viewpoint of improving heat resistance, in the polyethylene film of the present invention, it is important that, when a direction in which tensile strength is greatest is defined as a main orientation direction and a direction orthogonal to the main orientation direction in a plane of the film is defined as a main orientation orthogonal direction, a sum of a thermal shrinkage rate in the main orientation direction and a thermal shrinkage rate in the main orientation orthogonal direction when heated for eight hours at 100° C. be −5.0% or more and 10.0% or less. An upper limit of the sum of the thermal shrinkage rate in the main orientation direction and the thermal shrinkage rate in the main orientation orthogonal direction when heated for eight hours at 100° C. is preferably 8.0%, more preferably 6.0%, and still more preferably 4.0%. A lower limit of the sum of the thermal shrinkage rate in the main orientation direction and the thermal shrinkage rate in the main orientation orthogonal direction when heated for eight hours at 100° C. is preferably −2.0%, more preferably −1.0%, and still more preferably 0.0%, because there are cases where the film expands. Here, a thermal shrinkage rate of 0.0% means that a film neither shrinks nor expands, and a negative value means that the film does not shrink but expands. In a case where the film expands in the main orientation direction and in the main orientation orthogonal direction, or in a case where the film expands in one of the main orientation direction and the main orientation orthogonal direction and a degree of expansion thereof is larger than a degree of shrinkage in the other direction, the “sum of the thermal shrinkage rate in the main orientation direction and the thermal shrinkage rate in the main orientation orthogonal direction” has a negative value.

Herein, the main orientation direction in the present invention is a direction showing the largest value when the tensile strength is measured in each direction forming an angle of 0° to 175° at intervals of 5° with respect to an optional direction when a predetermined direction is defined as 0° in the film plane, and the main orientation orthogonal direction is a direction orthogonal to the main orientation direction in the film plane. The tensile strength can be measured according to a method defined in JIS K7161 (2014) using a tensile tester, and the details of a measurement method are shown in the examples.

When the width of a sample is less than 50 mm and the tensile strength cannot be obtained by a tensile tester, the crystal orientation of a (110) plane of the polyethylene film found by wide-angle X-rays is measured as follows and taken as the main orientation direction based on the following criteria. That is, X-rays (CuKα rays) are incident in a direction perpendicular to a film surface, a crystal peak at 2θ=about 22° ((110) plane) is scanned in a circumferential direction, a direction in which the diffraction intensity of the obtained diffraction intensity distribution is the highest is defined as a main orientation direction, and a direction orthogonal thereto is defined as a main orientation orthogonal direction. In the present invention, a direction parallel to a direction in which the polyethylene film is formed is referred to as a film formation direction, a longitudinal direction, or an MD direction, and a direction orthogonal to the film formation direction in the film plane is referred to as a width direction or a TD direction.

By setting the sum of the thermal shrinkage rate in the main orientation direction and the thermal shrinkage rate in the main orientation orthogonal direction when heated for eight hours at 100° C. to −5.0% or more and 10.0% or less or the above preferable ranges, dimensional stability of the polyethylene film is improved, and deterioration in quality such as wrinkling of the roll due to contraction and expansion of the polyethylene film can be reduced while such a polyethylene film is wound up and stored as a roll.

In order to set the sum of the thermal shrinkage rate in the main orientation direction and the thermal shrinkage rate in the main orientation orthogonal direction when heated for eight hours at 100° C. to −5.0% or more and 10.0% or less, for example, a method of setting the composition of the polyethylene film in a range that will be described later and setting the film formation conditions in the ranges that will be described later can be used. In particular, it is effective for the weight average molecular weight (which may hereinafter be referred to as a “weight average molecular weight” or a “weight average molecular weight of a film”) of the film measured using high-temperature GPC to be set to a range that will be described later, and for a film to be shrunk and relaxed at a high temperature in a heat treatment step.

From the viewpoint of enhancing the mechanical strength, the polyethylene film of the present invention has a tensile strength of 200 MPa or more and 5000 MPa or less in the main orientation orthogonal direction. From the above viewpoint, a lower limit of the tensile strength in the main orientation orthogonal direction is preferably 300 MPa, more preferably 400 MPa, still more preferably 450 MPa, and particularly preferably 500 MPa. Also, from the viewpoint of feasibility, an upper limit of the tensile strength in the main orientation orthogonal direction is preferably 2000 MPa and more preferably 1000 MPa. When the tensile strength in the main orientation orthogonal direction is set to 200 MPa or more and 5000 MPa or less, the film does not easily break even in cases where the film is thinned or used under high tension, and can be suitably used as a process film.

In order to set the tensile strength in the main orientation orthogonal direction to 200 MPa or more and 5000 MPa or less, for example, a method of setting the composition of the polyethylene film in a range that will be described later and setting the film formation conditions in the ranges that will be described later can be used. In particular, it is effective to set the molecular weight of the film to a range that will be described later and stretch the film at a high draw ratio.

In order to increase the tensile strength, it is common to perform stretching at a higher draw ratio, but when the draw ratio is increased, the thermal shrinkage rate may increase, and it has been conventionally difficult to achieve both a low thermal shrinkage rate and a high tensile strength in a polyethylene film. However, for example, when using the method of setting the composition of the polyethylene film in a range that will be described later and setting the film formation conditions in the ranges that will be described later, it is possible to achieve both the low thermal shrinkage rate and the high tensile strength. In order to achieve both the low thermal shrinkage rate and the high tensile strength, it is particularly effective to set the molecular weight of the film to a range that will be described later, and to cause the film to shrink and relax at a high temperature in the heat treatment step.

The polyethylene film of the present invention has an internal haze of 0% or more and 80% or less from the viewpoint of enhancing transparency. An upper limit of the internal haze is preferably 70%, more preferably 60%, still more preferably 50%, and particularly preferably 40%. A low internal haze means high transparency. When the internal haze is set to 0% or more and 80% or less, visibility after film bonding can be enhanced in a case where the polyethylene film is used as an adhesive film. In addition, in a case where the polyethylene film is used as an optical film, light transmittance can be enhanced. The internal haze can be measured by a haze meter, and the details of a measurement method are shown in the examples.

In order to set the internal haze to 0% or more and 80% or less, for example, a method of setting the composition of the polyethylene film in a range that will be described later and setting the film formation conditions in the ranges that will be described later can be used. In particular, it is effective to block voids in the film by performing heat treatment/re-stretching at a high temperature.

In the polyethylene film of the present invention, a ratio T1/T2 of the tensile elongation T1 in the main orientation direction and the tensile elongation T2 in the main orientation orthogonal direction is preferably 0.10 or more and 10 or less (hereinafter, a ratio between the tensile elongation T1 in the main orientation direction and the tensile elongation T2 in the main orientation orthogonal direction may be simply referred to as T1/T2). An upper limit of T1/T2 is more preferably 5.0, still more preferably 2.0, and particularly preferably 1.1, and a lower limit of T1/T2 is more preferably 0.20, still more preferably 0.50, and particularly preferably 0.60. When T1/T2 is set to 0.10 or more and 10 or less, the mechanical properties of the film become isotropic, and the film does not easily tear even in a case where the film is thinned or used under high tension, and can be suitably used as a process film.

In order to set T1/T2 in the above preferable range, a method of setting the composition of the polyethylene film and the film formation conditions to the ranges that will be described later can be used. In particular, it is effective to set the draw ratios in an MD direction and a TD direction in the ranges that will be described later.

In the polyethylene film of the present invention, the sum of the tensile elongation in the main orientation direction and the tensile elongation in the main orientation orthogonal direction is preferably 160% or more and 500% or less. A lower limit of the sum of the tensile elongation in the main orientation direction and the tensile elongation in the main orientation orthogonal direction is more preferably 170%, still more preferably 180%, and particularly preferably 190%, and an upper limit thereof is more preferably 450%, still more preferably 400%, and particularly preferably 350%. When the sum of the tensile elongation in the main orientation direction and the tensile elongation in the main orientation orthogonal direction is 160% or more and 500% or less, the film does not easily break even in cases where the film is used under high tension, and can be suitably used as a process film. The tensile elongation can be measured according to a method defined in JIS K7161 (2014) using a tensile tester, and the details of a measurement method are shown in the examples.

In order to set the sum of the tensile elongation in the main orientation direction and the tensile elongation in the main orientation orthogonal direction to 160% or more and 500% or less, for example, a method of setting the composition of the polyethylene film in a range that will be described later and setting the film formation conditions in the ranges that will be described later can be used. In particular, it is effective to set the draw ratios in an MD direction and a TD direction in the ranges that will be described later.

A thickness of the polyethylene film of the present invention is preferably 25 μm or less. An upper limit of the thickness is more preferably 20 μm, still more preferably 15 μm, and particularly preferably 10 μm. A lower limit is not particularly limited, and is substantially about 0.1 μm from the viewpoint of film formation possibility. When the thickness is set to 25 μm or less, followability to an adherend can be enhanced when the polyethylene film is used as a release film or a protective film. In addition, a volume can be reduced when it is used as a packaging film.

In order to set the thickness of the polyethylene film to 25 μm or less, a method of setting the film formation conditions of the polyethylene film to the ranges that will be described later can be used. In particular, it is effective to set the draw ratios in an MD direction and a TD direction in the ranges that will be described later. Also, the thickness can be adjusted by the screw rotation speed of the extruder, the width of the unstretched sheet, the film formation speed, the draw ratio, and the like within a range in which other physical properties do not deteriorate. The thickness of the polyethylene film can be measured with a known micro thickness meter, and the details of a measurement method are shown in the examples.

From the viewpoint of heat resistance and mechanical strength, in the polyethylene film of the present invention, a proportion of a crystal melting heat amount of 140° C. or higher to a total crystal melting heat amount in a temperature distribution curve of a crystal melting heat amount measured by differential scanning calorimetry is preferably 30% or more and 90% or less. A lower limit of the proportion of the crystal melting heat amount at 140° C. or higher to the total crystal melting heat amount is more preferably 40%, still more preferably 50%, and particularly preferably 60%. The proportion of the crystal melting heat amount at 140° C. or higher to the total crystal melting heat amount corresponds to a proportion of a structure composed of highly oriented molecular chains in the film, and when this value is 30% or more and 90% or less, the heat resistance and mechanical strength of the film are improved, and the film can be suitably used as a process film. The proportion of the crystal melting heat amount at 140° C. or higher to the total crystal melting heat amount can be measured by differential scanning calorimetry (DSC) based on JIS K7121 (2012), and the details of a measurement method are shown in the examples.

In order to set the proportion of the crystal melting heat amount at 140° C. or higher to the total crystal melting heat amount to 30% or more and 90% or less, for example, a method of setting the composition of the polyethylene film in a range that will be described later and setting the film formation conditions in the ranges that will be described later can be used. In particular, it is effective to set the molecular weight of the film to a range that will be described later and stretch the film at a high draw ratio.

From the viewpoint of enhancing mechanical strength and transparency, the polyethylene film of the present invention preferably has a Gurley value of 1×10⁴ sec/100 cm³ or more as measured by an Oken type air resistance meter. The Gurley value is more preferably 5×10⁴ sec/100 cm³ or more, still more preferably 7×10⁴ sec/100 cm³ or more, and particularly preferably 1×10⁵ sec/100 cm³ or more. Hereinafter, the Gurley value measured by the Oken type air resistance meter may be simply referred to as a “Gurley value”.

When the Gurley value is set to 1×10⁴ sec/100 cm³ or more, generation of voids penetrating in a thickness direction of the film can be suppressed, and the mechanical strength and transparency can be enhanced. An upper limit of the Gurley value is not particularly limited, and is about 1×10⁶ sec/100 cm³ in measurement. The Gurley value can be measured by an Oken type air resistance meter in accordance with JIS P-8117 (2009), the details of a measurement method are shown in the examples.

In order to set the Gurley value to 1×10⁴ sec/100 cm³ or more, for example, a method of setting the composition of the polyethylene film in a range that will be described later and setting the film formation conditions in the ranges that will be described later can be used. In particular, it is effective to block voids in the film by performing heat treatment/re-stretching at a high temperature.

From the viewpoint of enhancing the heat resistance and the mechanical strength, in the polyethylene film of the present invention, a weight average molecular weight (may be referred to as “weight average molecular weight” or “weight average molecular weight of film”) measured using high-temperature GPC is preferably 500,000 or more and 1.9 million or less. An upper limit of the weight average molecular weight of the film is more preferably 1.7 million, still more preferably 1.5 million, and a lower limit thereof is more preferably 700,000, and still more preferably 900,000. When the weight average molecular weight of the film is set to 1.9 million or less, a high molecular weight component that is difficult to relax can be suppressed, and the heat resistance of the film can be improved. When the weight average molecular weight of the film is 500,000 or more, the mechanical strength of the film can be improved. The weight average molecular weight of the film can be measured by high temperature GPC, and the details of a measurement method are shown in the examples.

In order to set the weight average molecular weight of the film to 500,000 or more and 1.9 million or less, a method of setting the composition of the polyethylene film in a range that will be described later and setting the film formation conditions in the ranges that will be described later can be used. In particular, it is effective to set the weight average molecular weight of the polyethylene resin to a range that will be described later.

From the viewpoint of enhancing the mechanical strength, in the polyethylene film of the present invention, a thermal conductivity in the main orientation direction is preferably 0.7 W/m/K or more. The thermal conductivity in the main orientation direction is more preferably 1.0 W/m/K or more, still more preferably 2.0 W/m/K or more, particularly preferably 3.0 W/m/K or more, and most preferably 5.0 W/m/K or more.

When the thermal conductivity in the main orientation direction is set to 0.7 W/m/K or more, the orientation of molecular chains of the film in the main orientation direction can be enhanced, and the mechanical strength can be enhanced. In addition, when used as a heat dissipation film, it is possible to improve diffusion of heat generated from a heat source. An upper limit of the thermal conductivity in the main orientation direction is not particularly limited, and is substantially about 5000 W/m/K, preferably about 100 W/m/K, and still more preferably about 30 W/m/K. The thermal conductivity in the main orientation direction can be measured by a photoalternating current method, and the details of a measurement method are shown in the examples.

In order to set the thermal conductivity in the main orientation direction to 0.7 W/m/K or more, for example, a method of setting the composition of the polyethylene film in a range that will be described later and setting the film formation conditions in the ranges that will be described later can be used. In particular, it is effective to set the molecular weight of the film to a range that will be described later and stretch the film at a high draw ratio after extracting the plasticizer.

Hereinafter, an ultrahigh molecular weight polyethylene resin (may be referred to as a polyethylene resin A) suitable as a component most contained in the polyethylene film of the present invention will be described. Here, the polyethylene resin A (ultrahigh molecular weight polyethylene) is polyethylene having a weight average molecular weight Mw of 500,000 or more, and for example, “HI-ZEX MILLION®” manufactured by Mitsui Chemicals, Inc. or “SUNFINE®” manufactured by Asahi Kasei Corporation can be used. In a case where a plurality of kinds of polyethylene resins satisfying the above requirements are contained, if the content when these components are summed exceeds 50% by mass of the entire film, it can be considered that the polyethylene resin A is contained in the largest amount.

The weight average molecular weight Mw of the polyethylene resin A is preferably 500,000 or more and 5 million or less from the viewpoint of achieving both the heat resistance and mechanical strength of the film. An upper limit of the Mw of the polyethylene resin A is more preferably 2 million, still more preferably 1.8 million, and particularly preferably 1.5 million, and a lower limit thereof is more preferably 700,000, still more preferably 900,000, and particularly preferably 1.1 million. The weight average molecular weight Mw of the polyethylene resin A can be measured by high temperature GPC, and the details of a measurement method are shown in the examples.

A melting point of the polyethylene resin A is preferably 120° C. or higher and 150° C. or lower from the viewpoint of achieving both heat resistance and film formability of the film. The upper limit of the melting point of the polyethylene resin A is more preferably 145° C., and still more preferably 140° C., and a lower limit thereof is more preferably 125° C., and still more preferably 130° C. The melting point of the polyethylene resin A can be measured by differential scanning calorimetry (DSC) according to JIS K7121 (2012), and the details of a measurement method are shown in the examples. The same applies to the melting point of a polyethylene resin B described later.

The polyethylene resin A may contain a copolymerization component and the like with another unsaturated hydrocarbon as long as the object of the present invention is not impaired. Examples of a monomer component constituting such a copolymerization component include propylene, 1-butene, 1-pentene, 3-methylpentene-1,3-methylbutene-1,1-hexene, 4-methylpentene-1,5-ethylhexene-1,1-octene, 1-decene, 1-dodecene, vinylcyclohexene, styrene, allylbenzene, cyclopentene, norbornene, 5-methyl-2-norbornene, vinyl acetate, methyl methacrylate, and styrene.

The copolymerization amount is preferably less than 10 mol %, and more preferably 5 mol % or less when the total amount of constituent units constituting the polyethylene resin A is 100 mol % from the viewpoint of dimensional stability in the form of a polyethylene film. Here, the copolymerization amount of the polyethylene resin A is calculated for the entire polyethylene resin A contained in the film. That is, not only in a case where the film is composed of only the polyethylene resin A containing less than 10 mol % of a copolymerization component, but also in a case where although the film contains the polyethylene resin A containing 10 mol % or more of a copolymerization component, a total amount of the copolymerization components is less than 10 mol % in the entire film, it can be considered that the copolymerization amount is less than 10 mol % when the total amount of structural units constituting the polyethylene resin A is 100 mol %. The same applies to the copolymerization amount of the polyethylene resin B described later.

The polyethylene film of the present invention may contain a polyethylene resin (polyethylene resin B) other than ultrahigh molecular weight polyethylene in addition to the polyethylene resin A. When the polyethylene film contains the polyethylene resin B, void formation in the film can be suppressed, and transparency can be enhanced. As the polyethylene resin B, high density polyethylene, low density polyethylene, ultralow density polyethylene, linear low density polyethylene, low molecular weight polyethylene, and the like can be used.

Here, the high density polyethylene is polyethylene having a density of 0.930 g/cm³ or more, and for example, “HI-ZEX®” manufactured by Prime Polymer Co., Ltd., “Evolue” H manufactured by Prime Polymer Co., Ltd., “SUNTEC®” HD manufactured by Asahi Kasei Corporation, and “NOVATEC” HD manufactured by Japan Polyethylene Corporation can be used.

The low density polyethylene is polyethylene having a density of 0.910 g/cm³ or more and less than 0.930 g/cm³, and for example, “SUNTEC®” LD manufactured by Asahi Kasei Corporation, “NOVATEC” LD manufactured by Japan Polyethylene Corporation, and the like can be used.

The ultralow density polyethylene is polyethylene having a density of less than 0.910 g/cm³, and for example, “LUMITAC®” manufactured by Tosoh Corporation can be used.

The linear low density polyethylene is polyethylene produced by a catalytic polymerization method among low density polyethylene, and for example, “Evolue®” manufactured by Prime Polymer Co., Ltd., “NOVATEC®” LL manufactured by Japan Polyethylene Corporation, and the like can be used.

The low molecular weight polyethylene is polyethylene having a weight average molecular weight of less than 100,000, and “Hi-Wax®” manufactured by Mitsui Chemicals, Inc., “SANWAX®” manufactured by Sanyo Chemical Industries, Ltd. and the like can be used.

Polyethylenes are classified according to a density, a production method, a molecular weight, and the like, and thus may correspond to two or more kinds, and in the present invention, a polyethylene resin having a weight average molecular weight of 500,000 or more is referred to as the polyethylene resin A, and a polyethylene resin having a weight average molecular weight of less than 500,000 is referred to as the polyethylene resin B.

The weight average molecular weight Mw of the polyethylene resin B is preferably 1000 or more and less than 500,000 from the viewpoint of enhancing the transparency of the film. From the above viewpoint, an upper limit of the Mw of the polyethylene resin B is more preferably 400,000, still more preferably 300,000, and particularly preferably 200,000, and a lower limit thereof is more preferably 5000, still more preferably 10,000, and particularly preferably 20,000.

A melting point of the polyethylene resin B is preferably 90° C. or higher and 140° C. or lower from the viewpoint of enhancing the transparency of the film. From the above viewpoint, an upper limit of the melting point of the polyethylene resin B is more preferably 135° C., still more preferably 130° C., and particularly preferably 125° C., and a lower limit thereof is more preferably 95° C., still more preferably 100° C., and particularly preferably 110° C.

The polyethylene resin B may contain a copolymerization component and the like with another unsaturated hydrocarbon as long as the object of the present invention is not impaired. Examples of a monomer component constituting such a copolymerization component include propylene, 1-butene, 1-pentene, 3-methylpentene-1,3-methylbutene-1,1-hexene, 4-methylpentene-1,5-ethylhexene-1,1-octene, 1-decene, 1-dodecene, vinylcyclohexene, styrene, allylbenzene, cyclopentene, norbornene, 5-methyl-2-norbornene, vinyl acetate, methyl methacrylate, and styrene. The copolymerization amount is preferably less than 10 mol %, and more preferably 5 mol % or less when the total amount of constituent units constituting the low molecular weight polyethylene resin is 100 mol % from the viewpoint of dimensional stability in the form of a polyethylene film.

The polyethylene film of the present invention may contain a resin other than the polyethylene as long as the object of the present invention is not impaired. Examples of the resin other than polyethylene include polypropylene, polymethylpentene, polybutene, an olefin-based thermoplastic elastomer, polystyrene, polyvinylidene fluoride, polyethylene oxide, and polyester. In a case where a resin other than polyethylene is contained, a content thereof is preferably less than 20% by mass, more preferably 15% by mass or less, still more preferably 10% by mass or less, and particularly preferably 5% by mass or less, based on 100% by mass of the total amount of the resin components, from the viewpoint of mechanical strength in the form of a polyethylene film.

The polyethylene film of the present invention can contain various additives, for example, a crystal nucleating agent, an antioxidant, a heat stabilizer, a sliding agent, an antistatic agent, an antiblocking agent, a filler, a viscosity modifier, a coloring inhibitor, and the like as long as the object of the present invention is not impaired. Among these, selection of the kind and addition amount of the antioxidant is important from the viewpoint of suppressing oxidation degradation due to a thermal history of the polyethylene resin. That is, the antioxidant is preferably a phenol-based antioxidant having steric hindrance, and at least one of the antioxidants is preferably a high molecular weight type having a molecular weight of 500 or more. Specific examples thereof include various examples, and for example, in combination with 2,6-di-t-butyl-p-cresol (BHT: molecular weight 220.4) it is preferable to use one or more kinds selected from 1,3,5-trimethyl-2,4,6-tris(3,5-di-t-butyl-4-hydroxybenzyl)benzene (for example, “Irganox®” 1330: molecular weight 775.2, manufactured by BASF) or tetrakis [methylene-3 (3,5-di-t-butyl-4-hydroxyphenyl) propionate]methane (for example, “Irganox®” 1010: molecular weight 1177.7, manufactured by BASF).

The total content of these antioxidants is preferably in the range of 0.01 parts by mass or more and 1.0 part by mass or less based on 100 parts by mass of the total amount of the polyethylene resin. When the amount of the antioxidant is 0.01 parts by mass or more, coloring of the film due to polymer degradation in the extrusion step can be suppressed, and long-term heat resistance can be improved. When the amount of the antioxidant is 1.0 parts by mass or less, bleeding out of the antioxidant can be suppressed to improve transparency of the polyethylene film. From the above viewpoint, a lower limit of the content of the antioxidant is more preferably 0.05 parts by mass, and still more preferably 0.1 parts by mass, and an upper limit thereof is more preferably 0.9 parts by mass, and still more preferably 0.8 parts by mass, based on 100 parts by mass of the total amount of the polyethylene resin.

The polyethylene film of the present invention preferably does not contain inorganic particles. Since the polyethylene resin that can be preferably used as a main component of the polyethylene film of the present invention has low affinity with inorganic particles, the inorganic particles may fall off from the film in the production process and contaminate the production line and the product. When coarse protrusions are formed by inorganic particles having high hardness, irregularities may be transferred to the resin layer of the optical member in the case of being used as a protective film or a process film of the optical member. Therefore, it may cause deterioration in quality when used as a protective film or a base material film for production of a product requiring high quality such as a display member. From the above viewpoints, the polyethylene film of the present invention preferably does not contain a lubricant such as organic particles.

In the polyethylene film of the present invention, a proportion of the polyethylene resin A and the polyethylene resin B in the total amount of 100% by mass of the resin components is preferably as follows. The amount of the polyethylene resin A is preferably more than 50% by mass and 100% by mass or less from the viewpoint of heat resistance and mechanical strength of the polyethylene film. From the above viewpoint, a lower limit of the proportion of the polyethylene resin A is more preferably 60% by mass, and still more preferably 70% by mass. The proportion of the polyethylene resin B is preferably 0% by mass or more and 40% by mass or less, and an upper limit thereof is more preferably 30% by mass, and still more preferably 10% by mass in the entire film. Here, “0% by mass” means that the component is not contained, and in a case where the polyethylene resin A occupies 100% by mass, the proportion of the polyethylene resin B is 0% by mass.

A layer configuration of the polyethylene film of the present invention is not particularly limited, and may have any configuration of a single layer or a laminate.

The polyethylene film of the present invention may contain only one kind of polyethylene resin layer, or may contain two or more kinds of polyethylene resin layers. The polyethylene resin layer is a layer containing a polyethylene resin in an amount of more than 50% by mass and 100% by mass or less, when all components constituting the layer is 100% by mass. In this case, in a case where two or more components corresponding to a polyethylene resins are contained in the layer, if the total amount of these components is more than 50% by mass and 100% by mass or less, the layer is regarded as a “layer containing a polyethylene resin as a main component”.

The content of the polyethylene resin in the “layer containing a polyethylene resin as a main component” is more preferably 90% by mass or more and 100% by mass or less, still more preferably 95% by mass or more and 100% by mass or less, still more preferably 96% by mass or more and 100% by mass or less, particularly preferably 97% by mass or more and 100% by mass or less, and most preferably 98% by mass or more and 100% by mass or less based on 100% by mass of all components constituting the layer. In a case where the polyethylene film of the present invention has a single-layer structure, the main component of the own polyethylene film is a polyethylene resin.

The polyethylene film of the present invention is preferably biaxially stretched using the resin described above. The biaxial stretching method may be any of an inflation simultaneous biaxial stretching method, a tenter simultaneous biaxial stretching method, and a sequential biaxial stretching method using a roll stretching machine and a tenter stretching machine. However, among these, it is preferable to adopt a tenter simultaneous biaxial stretching method or a sequential biaxial stretching method from the viewpoint of controlling film forming stability, thickness uniformity, and high rigidity and dimensional stability of the obtained polyethylene film, and it is preferable to include all the following steps (a) to (e). In particular, it is important to include a step (e) of heat treatment/re-stretching after extracting the plasticizer. Hereinafter, an example of a method for producing a polyethylene film using the above raw materials will be described, but the method for producing a polyethylene film of the present invention is not necessarily limited thereto.
(a) Preparing a polyethylene resin solution by kneading and dissolving a polymer material containing a polyethylene simple substance, a polyethylene mixture, a polyethylene solvent (plasticizer) mixture, an additive, and a polyethylene kneaded product
(b) Extruding a dissolved substance, molding the substance into a sheet, and cooling and solidifying the sheet
(c) Sequentially biaxially stretching or simultaneously biaxially stretching the obtained sheet by a roll stretching machine and/or a tenter stretching machine
(d) Thereafter, extracting a plasticizer from the obtained stretched film and drying the film
(e) Subsequently, performing heat treatment/re-stretching

Each of the steps will be described below.

### (a) Preparation of Polyethylene Resin Solution

A polyethylene resin solution is prepared by heating and dissolving a polyethylene resin in a plasticizer. In this case, as the polyethylene resin, polyethylene having a weight average molecular weight Mw of 500,000 or more and 5 million or less is preferable. The plasticizer is not particularly limited as long as it can sufficiently dissolve the polyethylene resin, and a plasticizer which is liquid at room temperature is preferable in order to enable stretching at a relatively high ratio. Examples of the plasticizer include: aliphatic, cycloaliphatic, or aromatic hydrocarbons such as nonane, decane, decalin, paraxylene, undecane, dodecane, and liquid paraffin; mineral oil distillate having a boiling point corresponding to such hydrocarbons; and phthalate esters such as dibutyl phthalate and dioctyl phthalate which are liquid at room temperature. Among these, in order to obtain a gel sheet in which a content of the plasticizer is stable, it is preferable to use a nonvolatile plasticizer such as liquid paraffin. Here, the gel sheet is a sheet-shaped molded body containing a liquid plasticizer at room temperature. In the melt-kneaded state, a plasticizer that is mixed with polyethylene but is solid at room temperature may be mixed with a liquid plasticizer at room temperature. Examples of the solid plasticizer at room temperature include stearyl alcohol, seryl alcohol, and paraffin wax. However, when only such a plasticizer is used, stretching unevenness and the like may occur.

A mixing ratio of the polyethylene resin and the plasticizer is set such that the total of the polyethylene resin and the plasticizer is 100% by mass, and the content of the polyethylene resin may be appropriately selected within a range not impairing molding processability, and is preferably 5% by mass or more and 90% by mass or less. And upper limit of the content of the polyethylene resin is more preferably 70% by mass, still more preferably 50% by mass, and particularly preferably 30% by mass, and a lower limit thereof is more preferably 7% by mass, still more preferably 10% by mass, and particularly preferably 15% by mass. When the content of the polyethylene resin is 5% by mass or more (the content of the plasticizer is 95% by mass or less), it is possible to suppress swell and neck-in at an outlet of a die to improve the moldability of a sheet and to improve the film formability at the time of molding into a sheet shape. On the other hand, when the content of the polyethylene resin is 90% by mass or less (the content of the plasticizer is 10% by mass or more), shrinkage in a thickness direction can be suppressed to improve molding processability.

A viscosity of the plasticizer which is liquid at room temperature is preferably 20 cSt or more and 200 cSt or less at 40° C. When the viscosity at 40° C. is 20 cSt or more, a sheet obtained by extruding the polyethylene resin solution from the die is less likely to be non-uniform. On the other hand, when the viscosity is 200 cSt or less, the plasticizer is easily removed. The viscosity of the plasticizer which is liquid at room temperature is a viscosity measured at 40° C. using an Ubbelohde viscometer.

### (b) Formation of Extrudate and Formation of Sheet

The method for uniformly melt-kneading the polyethylene resin solution is not particularly limited, and for example, in a case where it is desired to prepare a high-concentration polyethylene resin solution, it is preferable to perform the melt-kneading in a twin-screw extruder. If necessary, various additives such as an antioxidant may be added as long as the effect of the present invention is not impaired. In particular, it is preferable to add an antioxidant in order to prevent oxidation of the polyethylene resin.

In the extruder, the polyethylene resin solution is uniformly mixed at a temperature at which the polyethylene resin is completely melted. The melt-kneading temperature varies depending on the polyethylene resin to be used, and is preferably (melting point of polyethylene resin+10° C.) or higher and (melting point of polyethylene resin+120° C.) or lower. Specifically, the melt-kneading temperature is preferably 140° C. or higher and 260° C. or lower, and an upper limit thereof is more preferably 230° C., and still more preferably 210° C. A lower limit of the melt-kneading temperature is more preferably 150° C., still more preferably 160° C.

A lower melt-kneading temperature is preferable from the viewpoint of suppressing deterioration of the resin, and when the melt-kneading temperature is set to 260° C. or lower, thermal decomposition of polyethylene can be suppressed, and the mechanical strength of the resulting film can be improved. In addition, it is possible to suppress precipitation of the decomposition product on a chill roll, a roll in a stretching step, or the like, and to suppress deterioration of an appearance of the film. On the other hand, when the melt-kneading temperature is set to 140° C. or higher, an unmelted material in the extrudate extruded from the die can be suppressed, and breakage of the film in the subsequent stretching step can be prevented. After kneading within the above temperature range, it is preferable to remove foreign matters and modified polymers with a filter.

Next, the obtained extrudate is cooled to obtain a sheet containing polyethylene and a plasticizer, and a gel structure of the polyethylene resin containing the plasticizer can be fixed by cooling. A cooling temperature is preferably 10° C. or higher and 50° C. or lower. When the cooling temperature is set to the above preferable range, the gel structure is refined, and uniform stretching is easily performed in the subsequent stretching step.

Examples of the cooling method include a method of directly contacting with cold air, cooling water, or another cooling medium, a method of contacting with a roll cooled with a refrigerant, and a method of using a casting drum or the like.

### (c) Stretching Step

Next, the obtained sheet is stretched. Examples of the stretching method to be used include MD uniaxial stretching using a roll stretching machine, TD uniaxial stretching using a tenter stretching machine, sequential biaxial stretching using a combination of a roll stretching machine and a tenter stretching machine, or a combination of a tenter stretching machine and a tenter stretching machine, and simultaneous biaxial stretching using a simultaneous biaxial tenter stretching machine, and biaxial stretching is preferable from the viewpoint of controlling film forming stability, thickness uniformity, and high rigidity and dimensional stability of the resulting polyethylene film. A draw ratio varies depending on the thickness of the sheet, and is preferably 5.0 times or more in any direction from the viewpoint of uniformity of the film thickness. An area magnification is preferably 25.0 times or more, more preferably 49.0 times or more, and still more preferably 64.0 times or more. When the area magnification is 25.0 times or more, not only sufficient uniformity of the film can be realized, but also an unstretched portion hardly remains, so that the mechanical strength of the film is improved. Also, the area magnification is preferably 150.0 times or less, more preferably 120.0 times or less, and still more preferably 100.0 times or less. When the area magnification is 150.0 times or less, breakage during film production can be reduced.

A stretching temperature in each direction is preferably (melting point of sheet+10° C.) or lower, and specifically preferably 90° C. or higher and 130° C. or lower. An upper limit of the stretching temperature is more preferably 125° C., and still more preferably 120° C., and a lower limit thereof is more preferably 95° C., and still more preferably 100° C. When stretching at 90° C. or higher, stretching unevenness can be suppressed, and film thickness uniformity can be improved.

### (d) Plasticizer Extraction (Washing)/Drying Step

Next, the plasticizer remaining in the stretched sheet is removed using a washing solvent. Since a polyethylene resin phase and a plasticizer phase are separated, a polyethylene film is obtained by removing the plasticizer. Examples of the washing solvent include saturated hydrocarbons such as pentane, hexane, and heptane, chlorinated hydrocarbons such as methylene chloride and carbon tetrachloride, ethers such as diethyl ether and dioxane, ketones such as methyl ethyl ketone, and chain fluorocarbons such as trifluoroethane. These washing solvents are appropriately selected according to the plasticizer, and can be used singly or in combination.

A washing method can be performed by a method in which a stretched sheet is immersed in a washing solvent, a method in which a stretched sheet is showered with the washing solvent, a method using a combination thereof, or the like. A washing temperature is preferably 15° C. or higher and 30° C. or lower.

Thereafter, the washing solvent in the polyethylene film is dried and removed in a drying step. A drying method is not particularly limited, and a method using a metal heating roll, a method using hot air, or the like can be selected.

### (e) Heat Treatment/Re-Stretching Step

It is important that the dried polyethylene film be relaxed in a width direction and subjected to a heat treatment while both ends in the width direction are tensely gripped with clips. From the viewpoint of heat resistance of the film, a relaxation ratio is preferably 5.0% or more and 25% or less. An upper limit of the relaxation ratio is more preferably 20%, and still more preferably 18%. A lower limit thereof is more preferably 8.0%, still more preferably 10%, and particularly preferably 11% in consideration of the appearance during long-term storage. Also, a temperature of the heat treatment is preferably 130° C. or higher from the viewpoint of blocking voids in the film and enhancing the transparency of the film. From the above viewpoint, an upper limit of the temperature of the heat treatment is preferably 160° C., more preferably 155° C., and still more preferably 150° C. A lower limit thereof is more preferably 135° C., and still more preferably 140° C. When the relaxation ratio and the temperature of the heat treatment are set to be within the above ranges, the residual stress in the film can be relaxed and the thermal shrinkage rate can be reduced. After the heat treatment, it is preferable that the film be guided to the outside of the tenter through a cooling step at 50° C. or higher and 130° C. or lower while both end portions in the width direction be continuously tensely gripped with the clips, and the clips at both ends in the width direction be released. An upper limit of the temperature in the cooling step is more preferably 120° C., and still more preferably 110° C. Then, the film edge portion is slit in a winder step, and the polyethylene film is wound into a roll. For the heat treatment, a method of uniformly applying heat and pressure in the thickness direction of the film, such as roll press or belt press, may be used.

If necessary, it is preferable to stretch (re-stretch) the film in at least a uniaxial direction after the plasticizer extraction (washing) and drying step. In a case of performing re-stretching, a heat treatment is performed after the re-stretching. The re-stretching can be performed by a tenter stretching machine or the like in the same manner as the above-described stretching while heating the polyethylene film. The re-stretching may be uniaxial stretching or biaxial stretching. In a case of multi-stage stretching, the re-stretching is performed by combining the sequential stretching method and/or the simultaneous stretching method.

A re-stretching temperature is preferably 70° C. or higher and 160° C. or lower. An upper limit thereof is more preferably 150° C. and still more preferably 140° C. from the viewpoint of improving the mechanical strength of the film. A lower limit thereof is more preferably 80° C., and still more preferably 90° C. from the viewpoint of improving the transparency of the film. By performing re-stretching at a high temperature, voids in the film can be blocked, and the transparency of the film can be enhanced.

In the case of uniaxial stretching, the re-stretching ratio is preferably more than 1.00 time and 20 times or less, and particularly preferably more than 1.00 time and 10 times or less in the TD direction. A lower limit of the re-stretching ratio in the TD direction is more preferably 1.20 times, and still more preferably 1.50 times. In the case of biaxial stretching, stretching is preferably performed at a stretching ratio of more than 1.00 time and 5.00 times or less in each of the MD direction and the TD direction, and each of the MD direction and the TD direction may be different from each other. The re-draw ratio varies depending on the draw ratio in the above-mentioned stretching step, but it is preferable to adjust the re-draw ratio so that the final draw ratio (the product of the draw ratio in the stretching step and the re-draw ratio in the re-stretching step) is 500.0 times or less in terms of area magnification from the viewpoint of suppressing breakage of the film. The final draw ratio is more preferably 300.0 times or less, still more preferably 200.0 times or less, and particularly preferably 160.0 times or less. When the temperature and the ratio of the re-stretching are set to be within the above ranges, the crystal orientation proceeds, and the mechanical strength of the film can be improved.

### (f) Other Steps

Furthermore, the polyethylene film can be subjected to a hydrophilization treatment depending on other uses. The hydrophilization treatment can be performed by monomer grafting, a surfactant treatment, corona discharge, or the like. The monomer grafting is preferably conducted after the crosslinking treatment. The polyethylene film is preferably subjected to a crosslinking treatment by irradiation with an ionizing radiation such as an x ray, a B ray, a y ray, or an electron beam. In the case of electron beam irradiation, an electron dose is preferably 0.1 Mrad or more and 100 Mrad or less, and an acceleration voltage is preferably 100 kV or more and 300 kV or less.

In the case of a surfactant treatment, any of a nonionic surfactant, a cationic surfactant, an anionic surfactant, and a biionic surfactant can be used, and a nonionic surfactant is preferable. The polyethylene film is immersed in a solution obtained by dissolving a surfactant in water or a lower alcohol such as methanol, ethanol, or isopropyl alcohol, or the solution is applied to the polyethylene film by a doctor blade method.

In a case of corona discharge, it is preferable to perform a corona discharge treatment in air, nitrogen, carbon dioxide, or a mixed gas thereof.

In addition, a metal layer can be provided on at least one surface of the polyethylene film. In a case where a metal layer is applied to the polyethylene film, it is preferable to perform a hydrophilization treatment by corona discharge in order to improve adhesion of vapor-deposited metal. In the present invention, a method for applying the metal layer is not particularly limited, and the metal layer may be applied by electrothermal heating, sputtering, ion plating, ion beam, or the like using a continuous or batch type vacuum vapor deposition machine. For example, a method of depositing aluminum or an alloy of aluminum and zinc on at least one surface of a polyethylene film to provide a metal layer is preferably used. In this case, other metal components such as nickel, copper, gold, silver, and chromium may be deposited simultaneously with aluminum or sequentially. A thickness of a metal layer is not particularly limited, and is preferably 10 nm or more and 250 nm or less.

The polyethylene film of the present invention obtained as described above can be used in various industrial applications such as a packaging film, a surface protective film, a film for processes, a release film, a heat dissipation film, a low temperature film, a sliding film, a base material for an adhesive film, a sanitary product, an agricultural product, a building product, a medical product, and a film for capacitors, and can be preferably used as a packaging film, a surface protective film, a film for processes, a release film, a heat dissipation film, a low temperature film, and a base material for an adhesive film, in terms of particularly excellent in heat resistance, mechanical strength, quality, and transparency. Also, a metal layer laminated film obtained by applying a metal layer to at least one surface of the polyethylene film of the present invention can be preferably used as a radiant heat reflecting film, a packaging film, or a film for capacitors.

Herein, the surface protective film is a film that is attached to an object such as a molded body or a film, and has a function of preventing scratches, contamination, and the like generated during processing or transportation. The film for processes is a film that is attached to an object such as a molded body or a film to be prevented from scratches, contamination, and the like generated during producing or processing, and discarded when the final product is used. The release film is a film having high mold-releasing property, and having a function of preventing scratches, contamination, and the like generated during processing or transportation by being attached to an object such as a molded body or a film, and capable of being easily peeled and discarded when the final product is used. The packaging film is a film used for packaging foods and various products. The heat dissipation film is a film used for diffusing heat generated from a heat source such as an electronic component. The low temperature film is a film that is used at a low temperature of room temperature or lower, such as frozen packaging, or at a very low temperature such as in a liquid nitrogen environment. The adhesive film is a film obtained by providing an adhesive layer on one surface or both surfaces of a base material film, and is a film used by being attached to an adherend. The radiant heat reflecting film is a film used for heat shielding by reflecting radiant heat. Also, the film for capacitors is a film wound and used for a film capacitor.

### EXAMPLES

Hereinafter, the present invention will be described in more detail with reference to Examples. The characteristics were measured and evaluated by the following methods.

### (1) Film Thickness

A film thickness was measured using a micro thickness meter (manufactured by Anritsu Corporation). The film was sampled in a 10-cm square size, and the thickness was measured at five randomly selected points, and an average value of the obtained values was taken as the film thickness (μm).

### (2) Tensile Strength and Tensile Elongation

A rectangular sample having a length of 150 mm (measurement direction)×a width of 10 mm was cut out from the polyethylene film. The sample was set in a tensile tester (“TENSILON” UCT-100 manufactured by Orientec Co., Ltd.) at an initial distance between chucks of 50 mm. A tensile test of the film was performed at room temperature and a tensile speed of 300 mm/min. The tensile strength and the tensile elongation were calculated according to the method specified in JIS K7161 (2014). The measurement was performed 5 times for each sample, and the average value was taken as the tensile strength and tensile elongation of the sample.

### (3) Main Orientation Direction and Main Orientation Orthogonal Direction

A direction showing the largest value when the tensile strength was measured in each direction forming an angle of 0° to 175° at intervals of 5° with respect to a predetermined direction when the predetermined direction was set to 0° in the film plane was set as the main orientation direction, and a direction orthogonal to the main orientation direction in the film plane was set to the main orientation orthogonal direction. The tensile strength was measured by the method described in (2).

(4) Thermal Shrinkage Rate when Heated for Eight Hours at 100° C.

For the thermal shrinkage rate of the film, a film cut out into a 10-cm square having each side in the main orientation direction and the main orientation orthogonal direction of the film was heated in an oven heated to 100° C. for eight hours with both sides sandwiched between paper sheets having a thickness of 0.09 mm, and dimensional change rates of the film in the main orientation direction and the main orientation orthogonal direction before and after heating were measured. As for the dimensions, the length of a line connecting the center positions of the opposing sides of a 10-cm square film was used as a measurement position. The above measurement was performed five times at different positions in the same polyethylene film, and an average value thereof was taken as the thermal shrinkage rates in the main orientation direction and the main orientation orthogonal direction.

### (5) Internal Haze

A haze meter (HGM-2DP) manufactured by Suga Test Instruments Co., Ltd. was used. A sample was cut out into a size of 6.0 cm×3.0 cm, inserted into a quartz cell filled with purified water and having an optical path length of 1 cm, and subjected to measurement with light incident perpendicularly to a sample surface, thereby obtaining an internal haze value. The measurement was performed five times, and an average value thereof was adopted as the internal haze.

### (6) Melting Point of Polyethylene Film and Polyethylene Resin

The melting points of the polyethylene film and the polyethylene resin were measured by a differential scanning calorimetry (DSC) method in accordance with JIS K7121 (2012). 3.0 mg of a sample was sealed in an aluminum pan, and a temperature was raised from 25° C. to 250° C. at 20° C./min under a nitrogen atmosphere using a differential scanning calorimeter (EXSTAR DSC 6220 manufactured by Seiko Instruments Inc.), and a peak temperature of the obtained melting endothermic curve was defined as the melting point of the polyethylene film and the polyethylene resin.

### (7) Proportion of Crystal Melting Heat Amount at 140° C. or Higher to Total Crystal Melting Heat Amount

A ratio of the crystal melting heat amount of the polyethylene film at 140° C. or higher was calculated based on the result measured by a differential scanning calorimetry (DSC) method in accordance with JIS K7121 (2012). 3.0 mg of a sample was sealed in an aluminum pan, and the temperature was raised from 25° C. to 250° C. at 20° C./min in a nitrogen atmosphere using a differential scanning calorimeter (EXSTAR DSC 6220 manufactured by Seiko Instruments Inc.) to obtain a melting endothermic curve. For the obtained melting endothermic curve at the time of melting, a straight line baseline was set in the range of 60° C. to 200° C., and the heat amount was calculated from the area of the portion surrounded by the straight line baseline and the endothermic melting curve, and this was converted per sample mass to calculate the total melting heat amount Sₐₗₗ. In addition, the heat amount was calculated from the area of the portion surrounded by the straight line baseline and the endothermic melting curve at 140° C. or higher, and this was converted per sample mass to calculate a melting heat amount S_{≥140° C.} at 140° C. or higher. The obtained total melting heat amount Sₐₗₗ and the melting heat amount S_{≥140° C.} at 140° C. or higher were applied to the following equation to determine a ratio S of the crystal melting heat amount of the polyethylene film at 140° C. or higher. The measurement was performed three times for each sample, and an average value thereof was taken as the proportion of the crystal melting heat amount at 140° C. or higher to the total crystal melting heat amount of the sample.

$$S ( \% ) = {S}_{≧ 140 ° C .} \times 100 / {S}_{all} .$$

### (8) Gurley Value

The air resistance (see/100 cm³) of the polyethylene film was measured with an Oken type air resistance meter (EGO-1T, manufactured by Asahi Seiko Corporation) in accordance with JIS P-8117 (2009). The above measurement was performed at five different positions in the same polyethylene film, and an average value thereof was taken as the Gurley value of the film.

### (9) Weight Average Molecular Weight of Polyethylene Film and Polyethylene Resin

The weight average molecular weights of the polyethylene film and the polyethylene raw material were determined by a gel permeation chromatography (GPC) method under the following conditions.
Measuring device: GPC-150C manufactured by Waters Corporation
Column: Shodex UT806M manufactured by Showa Denko K.K.
Column temperature: 160° C.
Solvent (mobile phase): 1,2,4-trichlorochlorobenzene
Flow rate of solvent: 1.0 ml/min
Sample concentration: 0.1 wt % (dissolution conditions: 135° C./1 h)
Injection amount: 500 μl
Detector: Differential refractometer manufactured by Waters Corporation (RI detector)
Calibration curve: Created using a polyethylene conversion constant (0.46) from the calibration curve obtained by using monodispersed polystyrene standard sample.

### (10) Density of Polyethylene Film

The polyethylene film was sampled in a 10-cm square size, and the mass (kg) was measured. Subsequently, the volume (m³) was calculated using the thickness measured by the method described in (1), and the density (kg/m³) of the polyethylene film was calculated by the following equation.

$$Density ( kg / {m}^{3} ) = Mass ( kg ) / Volume ( {m}^{3} ) .$$

### (11) Specific Heat of Polyethylene Film

The specific heat of the polyethylene film was calculated based on the results of measurement by a differential scanning calorimetry (DSC) method under the following conditions in accordance with JIS K7123 (1987). The measurement was performed three times for each sample, and an average value thereof was taken as the specific heat of the sample.
Measuring device: Differential scanning calorimeter DSC 8500 manufactured by Perkin-Elmer Inc.
Heating rate: 10° C./min
Standard sample: Sapphire (α-Al₂O₃)
Atmosphere: In a dry nitrogen stream
Measurement temperature: 25° C.
Sample container: Aluminum container
   (12) Thermal conductivity in Main Orientation Direction

The thermal conductivity in the main orientation direction was measured by a photoalternating current method. A rectangular sample having a length of 30 mm (main orientation direction)×a width of 5 mm was cut out from the polyethylene film, colored with a black coating material, and used for the measurement. The sample was set in a thermal diffusivity measuring device (LaserPIT manufactured by ULVAC RIKO, Inc.), the sample was irradiated with a semiconductor laser in vacuum to be periodically heated, and the thermal diffusivity was determined from an attenuation constant of a temperature wave in the main orientation direction from the heating position. Using the density and specific heat of the polyethylene film measured by the method described in (10) and (11), the thermal conductivity of the polyethylene film in the main orientation direction was calculated by the following equation. The same measurement was performed three times, and an average value thereof was taken as the thermal conductivity of the sample in the main orientation direction.

Thermal conductivity(W/m/K)=Thermal diffusivity(m²/s)×Density(kg/m³)×Specific heat(J/kg/K)

### (13) Evaluation of Appearance During Long-Term Storage

A polyethylene film having a width of 500 mm was wound into a roll having a winding length of 200 m to form a film roll. The obtained film roll was stored at 50° C. for 200 hours, and the appearance of the film roll after storage and the flatness when the film roll was unwound by 1 m and a free tension (a state of being suspended in the vertical direction by the weight of the film) or a tension of 1 kg/m was uniformly applied to the entire film width without unevenness were visually confirmed and evaluated according to the following criteria.
S: There was no portion with poor appearance such as wrinkles and slack in the appearance of the film roll
A: A portion with poor appearance was observed in the appearance of the film roll, but a portion with poor flatness such as wrinkles, slack, and dents disappeared at the free tension.
B: A portion with poor flatness was observed at the free tension, but the portion with poor flatness disappeared at a tension of 1 kg/m.
C: A portion with poor flatness was observed even at a tension of 1 kg/m.

### (Polyethylene Resin or the Like)

Polyethylene resins having a weight average molecular weight Mw and a melting point Tm shown in Table 1 below were used for producing polyethylene films of Examples and Comparative Examples. These values are values evaluated in the form of resin pellets. Four kinds of resins were used as the polyethylene resin A, and five kinds of resins were used as the polyethylene resin B.

### <Polyethylene Resin A>

Polyethylene resin A1 (PE A1): Ultrahigh molecular weight polyethylene, “HI-ZEX Million®” 145M manufactured by Mitsui Chemicals, Inc.
Polyethylene resin A2 (PE A2): Ultrahigh molecular weight polyethylene, “SUNFINE®” UH650 manufactured by Asahi Kasei Corporation
Polyethylene resin A3 (PE A3): Ultrahigh molecular weight polyethylene, “HI-ZEX Million®” 240M manufactured by Mitsui Chemicals, Inc.
Polyethylene resin A4 (PE A4): Ultrahigh molecular weight polyethylene, “HI-ZEX Million®” 630M manufactured by Mitsui Chemicals, Inc.

### <Polyethylene Resin B>

Polyethylene resin B1 (PE B1): High density polyethylene, “Evolue®” H SP50800P manufactured by Prime Polymer Co., Ltd.
Polyethylene resin B2 (PE B2): Low density polyethylene, “NOVATEC®” LD LF128 manufactured by Japan Polyethylene Corporation
Polyethylene resin B3 (PE B3): High density polyethylene, “NOVATEC®” HD HF111K manufactured by Japan Polyethylene Corporation
Polyethylene resin B4 (PE B4): High density polyethylene, “SUNFINE®” SH800 manufactured by Asahi Kasei Corporation
Polyethylene resin B5 (PE B5): Low molecular weight polyethylene, Paraffin Wax-155 manufactured by Nippon Seiro Co., Ltd.

TABLE 1

| | | Mw | | Tm (° C.) |
|---|---|---|---|---|
| Polyethylene | PE A1 | 1.1 | million | 134 |
| resin A | PE A2 | 800,000 | | 136 |
| | PE A3 | 2 | million | 132 |
| | PE A4 | 5.8 | million | 133 |

| | | | |
|---|---|---|---|
| Polyethylene | PE B1 | 50,000 | 126 |
| resin B | PE B2 | 120,000 | 111 |
| | PE B3 | 200,000 | 130 |
| | PE B4 | 350,000 | 136 |
| | PE B5 | 500 | 69 |

### Example 1

0.04 parts by mass of “Irganox®” 1010 manufactured by BASF SE as an antioxidant was mixed with 20 parts by mass of the polyethylene resin A1, and supplied to a twin-screw extruder. 80 parts by mass of liquid paraffin (35 cSt (40° C.)) as a plasticizer was supplied from a side feeder of the twin-screw extruder, and then melt-kneaded at 180° C. to prepare a polyethylene resin solution. The polyethylene resin solution was extruded from a twin screw extruder, passed through a filter to remove foreign substances, and supplied to a T-shaped die. The sheet-like extruded product was cooled and solidified while being taken up by a cooling roll temperature-controlled to 30° C. to obtain a gel sheet. The take-up speed at this time was 5 m/min. The obtained gel-like sheet was stretched 9.6 times in the MD direction at 120° C. by a roll stretching machine, and then stretched 10 times in the TD direction at 120° C. by a tenter stretching machine. The film after being stretched was immersed in a methylene chloride bath whose temperature was adjusted to 25° C. in a washing tank to remove liquid paraffin, and air-dried at room temperature. Next, the film after being dried was re-stretched 1.56 times in the TD direction at 120° C. by a tenter stretching machine, and then subjected to heat treatment at 146° C. while being relaxed by 12% in the TD direction. Further, the film was guided to the outside of a tenter stretching machine through a cooling step at 100° C., the clips at both ends in the width direction were released, the film edge portion was slit in a winder step, and the film was wound around a core to obtain a polyethylene film having a thickness of 5 μm. The physical properties and evaluation results of the obtained film are shown in Table 2.

### Examples 2 to 9 and Comparative Examples 1 to 3, 5, and 6

A polyethylene film was obtained in the same manner as in Example 1 except that the composition and film formation conditions were as shown in Table 2. In this case, the thickness was adjusted by adjusting the discharge amount in extrusion and adjusting the speed of the casting drum (hereinafter, the same applies to other Examples and Comparative Examples). The physical properties and evaluation results of the obtained film are shown in Table 2.

### Comparative Example 4

A polyethylene film was obtained in the same manner as in Example 1 except that the composition and film formation conditions were set as shown in Table 2, and the film was re-stretched after the first stretching without being immersed in a methylene chloride bath.

### Example 10

A film surface (cooling roll contact surface side) of a polyethylene film prepared under the film formation conditions described in Example 1 was subjected to a corona discharge treatment at a treatment intensity of 25 W·min/m², and wound up as a film roll. Thereafter, a film roll was set in a vacuum vapor deposition apparatus equipped with a film traveling device, and brought into a high pressure reduction state of 1.00×10⁻² Pa. Thereafter, the film was caused to travel through a cooling metal drum at 20° C., and aluminum metal was heated and evaporated to form a vapor-deposited thin-film layer on the film surface (cooling roll contact surface side). At this time, the vapor-deposited film was controlled to have a thickness of about 100 nm. After the vapor deposition, the inside of the vacuum vapor deposition apparatus was returned to normal pressure to obtain a metal layer laminated film having a metal layer on one surface. The metal layer laminated film thus obtained was not wrinkled and could be uniformly deposited.

### Example 11

A film surface (cooling roll contact surface side) of a polyethylene film prepared under the film formation conditions described in Example 1 was subjected to a corona discharge treatment at a treatment intensity of 25 W·min/m². Thereafter, a coating agent for adhesive layers in which an acrylic based adhesive (“SK Dyne®” 1310 manufactured by Soken Chemical & Engineering Co., Ltd.) was diluted with ethyl acetate, toluene, and methyl ethyl ketone (MEK), and 2.0 parts by mass of a curing agent (“CORONATE®” D-90 manufactured by Nippon Polyurethane Industry Co., Ltd.) was mixed with 100 parts by mass of the solid content of the adhesive was applied to a film surface (cooling roll contact surface side) using Gravure coater. Subsequently, the film was guided to a drying furnace at 80° C. and conveyed for 30 seconds to remove the solvent in the coating agent, thereby obtaining an adhesive film having an adhesive layer thickness of 0.7 μm. The adhesive film thus obtained was wrinkle-free and was capable of uniformly applying the adhesive layer.

TABLE 2-1

| | | | Example 1 | Example 2 | Example 3 | Example 4 | Example 5 | Example 6 |
|---|---|---|---|---|---|---|---|---|
| Polyethylene resin A | PE A1 | Parts by mass | 20 | 20 | 17.5 | 15 | — | — |
| | PE A2 | Parts by mass | — | — | — | — | 30 | — |
| | PE A3 | Parts by mass | — | — | — | — | — | 16.5 |
| | PE A4 | Parts by mass | — | — | — | — | — | — |
| Polyethylene resin B | PE B1 | Parts by mass | — | — | 7.5 | — | — | — |
| | PE B2 | Parts by mass | — | — | — | 10 | — | — |
| | PE B3 | Parts by mass | — | — | — | — | — | 13.5 |
| | PE B4 | Parts by mass | — | — | — | — | — | — |
| | PE B5 | Parts by mass | — | — | — | — | — | — |
| Antioxidant | | Parts by mass | 0.04 | 0.04 | 0.05 | 0.05 | 0.06 | 0.06 |
| Plasticizer | | Parts by mass | 80 | 80 | 75 | 75 | 70 | 70 |
| Ratio of polyethylene resin A | | % by mass | 100 | 100 | 70 | 60 | 100 | 55 |
| to entire polyethylene resin | | | | | | | | |
| Stretching method | | — | Sequential | Sequential | Sequential | Sequential | Simultaneous | Simultaneous |
| | | | biaxial | biaxial | biaxial | biaxial | biaxial | biaxial |
| Longitudinal stretching | Temperature | ° C. | 120 | 120 | 118 | 118 | 115 | 118 |
| (MD direction) | Draw ratio | Times | 9.6 | 6 | 6 | 6 | 5 | 6 |
| Lateral stretching | Temperature | ° C. | 120 | 120 | 118 | 118 | 115 | 118 |
| (TD direction) | Draw ratio | Times | 10 | 8.2 | 8.2 | 8.2 | 5 | 6 |
| Re-stretching method | | — | Uniaxial | Sequential | Sequential | — | Sequential | Sequential |
| | | | | biaxial | biaxial | | biaxial | biaxial |
| Re-longitudinal | Temperature | ° C. | — | 80 | 120 | — | 100 | 130 |
| stretching | Draw ratio | Times | — | 2.5 | 1.5 | — | 1.2 | 2 |
| (MD direction) | | | | | | | | |
| Re-lateral stretching | Temperature | ° C. | 120 | 120 | 120 | — | 120 | 130 |
| (TD direction) | Draw ratio | Times | 1.56 | 1.1 | 1.5 | — | 1.56 | 2 |
| Heat treatment | Temperature | ° C. | 146 | 146 | 144 | 138 | 146 | 146 |
| | Relaxation | % | 12 | 7.5 | 5 | 10 | 12 | 5 |
| | ratio | | | | | | | |
| Final magnification | MD | Times | 9.6 | 15 | 9 | 6 | 6 | 12 |
| | TD | Times | 15.6 | 9.02 | 12.3 | 8.2 | 7.8 | 12 |
| | Area | Times | 149.8 | 135.3 | 110.7 | 49.2 | 46.8 | 144.0 |
| | magnification | | | | | | | |

| | | | | | | | |
|---|---|---|---|---|---|---|---|
| Thickness | μm | 5 | 10 | 10 | 10 | 15 | 10 |
| Internal haze | % | 46 | 58 | 12 | 2 | 72 | 36 |
| Main orientation direction | — | TD | MD | TD | TD | MD | TD |
| Tensile strength in main | MPa | 760 | 720 | 400 | 270 | 420 | 560 |
| orientation direction | | | | | | | |
| Tensile strength in main | MPa | 550 | 450 | 360 | 250 | 410 | 480 |
| orientation orthogonal direction | | | | | | | |
| Tensile elongation T1 in main | % | 42 | 50 | 92 | 144 | 150 | 62 |
| orientation direction | | | | | | | |
| Tensile elongation T2 in main | % | 68 | 83 | 90 | 182 | 160 | 50 |
| orientation orthogonal direction | | | | | | | |
| Tensile elongation ratio T1/T2 | — | 0.62 | 0.60 | 1.02 | 0.79 | 0.94 | 1.24 |
| Sum of tensile elongations T1 + T2 | % | 110 | 133 | 182 | 326 | 310 | 112 |
| Sum of thermal shrinkage rates at 100° | % | 3.8 | 7.5 | 9.9 | 4.7 | 4.4 | 8.1 |
| C. in main orientation direction and | | | | | | | |
| main orientation orthogonal direction | | | | | | | |
| Proportion of crystal melting | % | 60 | 72 | 30 | 22 | 63 | 55 |
| heat amount at 140° C. or higher | | | | | | | |
| Gurley value | sec/100 cm³ | 1 × 10⁵ | 1 × 10⁵ | 1 × 10⁵ | 1 × 10⁵ | 4 × 10⁴ | 1 × 10⁵ |
| Weight average molecular weight | — | 1.1 million | 1.1 million | 800,000 | 800,000 | 780,000 | 1.7 million |
| of film | | | | | | | |
| Thermal conductivity in main | W/m/K | 4.2 | 3.7 | 3.1 | 2.8 | 1.6 | 4.9 |
| orientation direction | | | | | | | |
| Evaluation of appearance during | — | S | A | A | S | S | A |
| long-term storage | | | | | | | |

TABLE 2-2

| | | | | | | Comparative | Comparative |
|---|---|---|---|---|---|---|---|
| | | | Example 7 | Example 8 | Example 9 | Example 1 | Example 2 |
| Polyethylene resin A | PE A1 | Parts by mass | — | — | 15 | — | — |
| | PE A2 | Parts by mass | — | 10 | 10 | — | — |
| | PE A3 | Parts by mass | 16.5 | 10 | — | 10 | 9 |
| | PE A4 | Parts by mass | — | — | — | — | — |
| Polyethylene resin B | PE B1 | Parts by mass | — | — | — | — | — |
| | PE B2 | Parts by mass | — | — | — | — | — |
| | PE B3 | Parts by mass | 13.5 | — | — | — | — |
| | PE B4 | Parts by mass | — | — | — | — | 21 |
| | PE B5 | Parts by mass | — | — | — | — | — |
| Antioxidant | | Parts by mass | 0.06 | 0.04 | 0.05 | 0.02 | 0.06 |
| Plasticizer | | Parts by mass | 70 | 80 | 75 | 90 | 70 |
| Ratio of polyethylene resin A | | % by mass | 55 | 100 | 100 | 100 | 30 |
| to entire polyethylene resin | | | | | | | |
| Stretching method | | — | Simultaneous | Simultaneous | Simultaneous | Simultaneous | Simultaneous |
| | | | biaxial | biaxial | biaxial | biaxial | biaxial |
| Longitudinal stretching | Temperature | ° C. | 118 | 120 | 120 | 120 | 115 |
| (MD direction) | Draw ratio | Times | 6 | 5 | 6 | 10 | 5 |
| Lateral stretching | Temperature | ° C. | 118 | 120 | 120 | 120 | 115 |
| (TD direction) | Draw ratio | Times | 6 | 5 | 6 | 10 | 5 |
| Re-stretching method | | — | Uniaxial | Sequential | Sequential | — | — |
| | | | | biaxial | biaxial | | |
| Re-longitudinal | Temperature | ° C. | — | 140 | 140 | — | — |
| stretching | Draw ratio | Times | — | 2 | 3 | — | — |
| (MD direction) | | | | | | | |
| Re-lateral stretching | Temperature | ° C. | 130 | 130 | 120 | — | — |
| (TD direction) | Draw ratio | Times | 3.2 | 4.8 | 1.2 | — | — |
| Heat treatment | Temperature | ° C. | 146 | 128 | 132 | 148 | 146 |
| | Relaxation | % | 5 | 15 | 10 | 0 | 0 |
| | ratio | | | | | | |
| Final magnification | MD | Times | 6 | 10 | 18 | 10 | 5 |
| | TD | Times | 19.2 | 24 | 7.2 | 10 | 5 |
| | Area | Times | 115.2 | 240.0 | 129.6 | 100.0 | 25.0 |
| | magnification | | | | | | |

| | | | | | | |
|---|---|---|---|---|---|---|
| Thickness | μm | 12 | 18 | 24 | 1.2 | 10 |
| Internal haze | % | 44 | 3 | 39 | 30 | 62 |
| Main orientation direction | — | TD | TD | MD | TD | MD |
| Tensile strength in main | MPa | 820 | 610 | 870 | 420 | 320 |
| orientation direction | | | | | | |
| Tensile strength in main | MPa | 220 | 300 | 210 | 400 | 300 |
| orientation orthogonal direction | | | | | | |
| Tensile elongation T1 in main | % | 28 | 51 | 18 | 36 | 192 |
| orientation direction | | | | | | |
| Tensile elongation T2 in main | % | 94 | 55 | 160 | 30 | 210 |
| orientation orthogonal direction | | | | | | |
| Tensile elongation ratio T1/T2 | — | 0.30 | 0.93 | 0.06 | 1.20 | 0.91 |
| Sum of tensile elongations T1 + T2 | % | 122 | 106 | 178 | 66 | 402 |
| Sum of thermal shrinkage rates at 100° | % | 7.2 | 3.2 | 9.1 | 32.0 | 11.4 |
| C. in main orientation direction and | | | | | | |
| main orientation orthogonal direction | | | | | | |
| Proportion of crystal melting | % | 65 | 58 | 50 | 48 | 40 |
| heat amount at 140° C. or higher | | | | | | |
| Gurley value | sec/100 cm³ | 1 × 10⁵ | 1 × 10⁵ | 3 × 10⁴ | 1 × 10⁵ | 1 × 10⁵ |
| Weight average molecular weight | — | 1.7 million | 1.5 million | 1 million | 2 million | 1.3 million |
| of film | | | | | | |
| Thermal conductivity in main | W/m/K | 6.5 | 5.2 | 12.5 | 1.2 | 0.5 |
| orientation direction | | | | | | |
| Evaluation of appearance during | — | A | S | A | C | B |
| long-term storage | | | | | | |

TABLE 2-3

| | | | Comparative | Comparative | Comparative | Comparative |
|---|---|---|---|---|---|---|
| | | | Example 3 | Example 4 | Example 5 | Example 6 |
| Polyethylene resin A | PE A1 | Parts by mass | — | 50 | — | — |
| | PE A2 | Parts by mass | — | — | — | — |
| | PE A3 | Parts by mass | — | — | — | — |
| | PE A4 | Parts by mass | 5 | — | — | 5 |
| Polyethylene resin B | PE B1 | Parts by mass | — | — | — | 5 |
| | PE B2 | Parts by mass | — | — | — | — |
| | PE B3 | Parts by mass | — | — | — | — |
| | PE B4 | Parts by mass | — | — | 30 | — |
| | PE B5 | Parts by mass | — | 50 | — | — |
| Antioxidant | | Parts by mass | 0.01 | 0.2 | 0.06 | 0.02 |
| Plasticizer | | Parts by mass | 95 | 0 | 70 | 90 |
| Ratio of polyethylene resin A | | % by mass | 100 | 50 | 0 | 50 |
| to entire polyethylene resin | | | | | | |
| Stretching method | | — | Uniaxial | Simultaneous | Simultaneous | Sequential |
| | | | | biaxial | biaxial | biaxial |
| Longitudinal stretching | Temperature | ° C. | 130 | 120 | 115 | 120 |
| (MD direction) | Draw ratio | Times | 12 | 7 | 5 | 5 |
| Lateral stretching | Temperature | ° C. | — | 120 | 115 | 130 |
| (TD direction) | Draw ratio | Times | — | 7 | 5 | 6 |
| Re-stretching method | | — | Uniaxial | Simultaneous | — | Uniaxial |
| | | | | biaxial | | |
| Re-longitudinal | Temperature | ° C. | 140 | 120 | — | — |
| stretching | Draw ratio | Times | 12 | 2 | — | — |
| (MD direction) | | | | | | |
| Re-lateral stretching | Temperature | ° C. | — | 120 | — | 130 |
| (TD direction) | Draw ratio | Times | — | 2 | — | 1.4 |
| Heat treatment | Temperature | ° C. | — | — | 125 | 162 |
| | Relaxation | % | — | — | 0 | 5 |
| | ratio | | | | | |
| Final magnification | MD | Times | 144 | 14 | 5 | 5 |
| | TD | Times | 1 | 14 | 5 | 8.4 |
| | Area | Times | 144.0 | 196.0 | 25.0 | 42.0 |
| | magnification | | | | | |

| | | | | | |
|---|---|---|---|---|---|
| Thickness | μm | 10 | 2.5 | 30 | 18 |
| Internal haze | % | 85 | 20 | 88 | 42 |
| Main orientation direction | — | MD | MD | TD | TD |
| Tensile strength in main | MPa | 1500 | 400 | 80 | 300 |
| orientation direction | | | | | |
| Tensile strength in main | MPa | 140 | 390 | 78 | 190 |
| orientation orthogonal direction | | | | | |
| Tensile elongation T1 in main | % | 12 | 10 | 110 | 50 |
| orientation direction | | | | | |
| Tensile elongation T2 in main | % | 182 | 16 | 158 | 121 |
| orientation orthogonal direction | | | | | |
| Tensile elongation ratio T1/T2 | — | 0.07 | 0.63 | 0.70 | 0.41 |
| Sum of tensile elongations T1 + T2 | % | 194 | 26 | 268 | 171 |
| Sum of thermal shrinkage rates at 100° | % | 21.2 | 39.0 | 23.9 | 10.3 |
| C. in main orientation direction and | | | | | |
| main orientation orthogonal direction | | | | | |
| Proportion of crystal melting | % | 67 | 16 | 8 | 32 |
| heat amount at 140° C. or higher | | | | | |
| Gurley value | sec/100 cm³ | 8 × 10³ | 1 × 10⁵ | 4 × 10² | 4 × 10⁴ |
| Weight average molecular weight | — | 5.4 million | 460,000 | 350,000 | 3.2 million |
| of film | | | | | |
| Thermal conductivity in main | W/m/K | 14.1 | 0.6 | 0.2 | 1.5 |
| orientation direction | | | | | |
| Evaluation of appearance during | — | C | C | C | B |
| long-term storage | | | | | |

### INDUSTRIAL APPLICABILITY

The polyethylene film of the present invention can be used in various industrial applications such as a packaging film, a surface protective film, a film for processes, a heat dissipation film, a low temperature film, a sliding film, a base material for an adhesive film, a sanitary product, an agricultural product, a building product, a medical product, and a film for capacitors, and can be preferably used as a surface protective film, a film for processes, a release film, packaging film, a heat dissipation film, a low temperature film, and a base material for an adhesive film, in terms of particularly excellent in heat resistance, mechanical strength, quality, and transparency.

1. A polyethylene film, wherein, when a direction in which tensile strength is greatest is defined as a main orientation direction and a direction orthogonal to the main orientation direction in a plane of the film is defined as a main orientation orthogonal direction, a sum of a thermal shrinkage rate in the main orientation direction and a thermal shrinkage rate in the main orientation orthogonal direction when heated for eight hours at 100° C. is −5.0% or more and 10.0% or less, a tensile strength in the main orientation orthogonal direction is 200 MPa or more and 5000 MPa or less, and an internal haze is 0% or more and 80% or less.

2. The polyethylene film according to claim 1, wherein a ratio T1/T2 of tensile elongation T1 in the main orientation direction and tensile elongation T2 in the main orientation orthogonal direction is 0.10 or more and 10 or less.

3. The polyethylene film according to claim 1, wherein a sum of the tensile elongation in the main orientation direction and the tensile elongation in the main orientation orthogonal direction is 160% or more and 500% or less.

4. The polyethylene film according to claim 1, wherein a proportion of a crystal melting heat amount of 140° C. or higher to a total crystal melting heat amount in a temperature distribution curve of a crystal melting heat amount measured by differential scanning calorimetry is 30% or more and 90% or less.

5. The polyethylene film according to claim 1, wherein a Gurley value measured with an Oken type air resistance meter is 1×10⁴ sec/100 cm³ or more.

6. The polyethylene film according to claim 1, wherein a weight average molecular weight measured using high-temperature GPC is 500,000 or more and 1.9 million or less.

7. The polyethylene film according to claim 1, comprising, as a main component, polyethylene having a weight average molecular weight of 500,000 or more and 5 million or less.

8. The polyethylene film according to claim 1, wherein a thermal conductivity in the main orientation direction is 0.7 W/m/K or more.

9. The polyethylene film according to claim 1, wherein a thickness is 25 μm or less.

10. An adhesive film obtained by providing an adhesive layer on one surface or both surfaces of the polyethylene film according to claim 1.

11. A metal layer laminated film comprising a metal layer on at least one surface of the polyethylene film according to claim 1.

12. A release film comprising the polyethylene film according to claim 1.

13. A heat dissipation film comprising the polyethylene film according to claim 1.

14. A low temperature film comprising the polyethylene film according to claim 1.

15. A polyethylene film roll obtained by winding the polyethylene film according to claim 1 around a core.

16. A method for producing a polyethylene film having an internal haze of 0% or more and 80% or less, the method comprising a heat treatment step of biaxially stretching a sheet containing polyethylene having a weight average molecular weight Mw of 500,000 or more and 5 million or less and a plasticizer, extracting the plasticizer, and then subjecting the sheet to a heat treatment.

17. The method for producing a polyethylene film according to claim 16, wherein a temperature in the heat treatment step is 130° C. or higher.

18. The method for producing a polyethylene film according to claim 16, comprising a step of stretching in at least a uniaxial direction after extracting the plasticizer.

19. The method for producing a polyethylene film according to claim 16, wherein a sum of a thermal shrinkage rate in the main orientation direction and a thermal shrinkage rate in the main orientation orthogonal direction when heated for eight hours at 100° C. is −5.0% or more and 10.0% or less.

20. The method for producing a polyethylene film according to claim 16, wherein a tensile strength in the main orientation orthogonal direction is 200 MPa or more and 5000 MPa or less.
